(19) United States
(12) Patent Application Publication
(10) Pub. No.: US 2004/0252286 A1
(43) Pub. Date: Dec. 16, 2004

(54) Method and apparatus for printing a special effect preview print

(75) Inventors: Thomas J. Murray, Cohocton, NY (US); John P. Kopcienski, Spencerport, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/458,233

(22) Filed: Jun. 10, 2003

(51) Int. Cl. G03B 29/00

(52) U.S. Cl. 355/28; 355/27; 355/40

(57) ABSTRACT

The present invention relates to a method and apparatus for printing and/or displaying a customer image order in which a digital record of a customer order containing a plurality of images is obtained. In the method and apparatus of invention, at least one image is selected for printing or displaying as a special effect preview print. This selected image can be modified so as to form a special effect image. The modification is preferably a modification which involves the creation of a black and white image, a sepia image, high color saturation, a cartoon image, bordered image, etc. This provides the consumer with an opportunity to view their originally captured image in a form where the image has a different appearance, characteristic, or look applied to it.

### FIELD OF THE INVENTION

The present invention relates to the printing of images, and particularly, the printing of a special effect preview print in addition to prints as requested by a consumer or customer.

### BACKGROUND OF THE INVENTION

With the advent of digital printing onto media many more opportunities are provided for improving the quality of the output of the image. As an example, quality of the output of the image is particularly important when images are produced by printing on a photographic media such as photographic film. With the advent of digital printing, various enhancements, corrections, and/or alterations may be provided for printing of images from film so as to compensate for poor flash or lighting during the taking of the image by the camera, or other flaws caused by the camera or picture taker. Use of a digital printer also allows enhancements in sharpness and dust and scratch removal. Digital printers also permit corrections with respect to red eye, tone scale, underexposure and noise etc.

In addition to the above improvements, digital printers also permit a modification of the image as submitted by the consumer so as to provide a unique appearance characteristic or look to the image. That is, consumers are familiar with traditional photographs which are typically 4×6 inch color prints. With the advent of digital technology, it is possible to create a print having an image provided by the consumer wherein a special effect or modified appearance characteristic or look has been applied to the image. This permits the consumer or customer to preview this type of technology and/or image modification. This also provides the consumer with a new way to enjoy their pictures and at the same time have their traditional photo.

### SUMMARY OF THE INVENTION

The present invention provides for a method and apparatus for creating a special effect preview print wherein an image as submitted by a consumer or customer for photofinishing can be printed in a traditional manner, such as a 4×6 color print, and in addition, can be modified in a manner in which the appearance characteristics or look of the image is changed. One option for providing a special effect preview print to the consumer involves providing the print as originally requested by the consumer as a 4×6 color print with one or two wallet prints attached which are typically 2×3. These wallet prints would be copies of the full size prints with the exception of the size of the print, and in addition, the images in the wallet size prints would have a modified appearance characteristics or look different from that of the image in the traditional 4×6 print.

With the method and apparatus of the present invention, a consumer can enjoy a different look for their prints by receiving a special effect preview print which includes an image that has a special effect or appearance characteristics applied thereto. Examples of different appearance characteristics or look modifications that can be applied to the consumer's images includes providing a border around the image, or changing the color of the image so as to produce, for example, a black and white wallet print, a sepia print, a cartoon print, etc. With the method and apparatus of the present invention, it is possible to provide the consumer with the opportunity to preview their submitted image in a different format i.e., as a modified image wherein the appearance characteristic or look has been changed.

The present invention accordingly provides for an imaging service method which comprises the steps of obtaining a digital record of a customer image order containing a plurality of images; selecting at least one image from the plurality of images for printing as a special effect preview print; reading the at least one image to find a region of interest in the at least one image; zooming and cropping around the region of interest in the at least one image; rendering the at least one image as a first image in accordance with instructions from the customer in the image order; and rendering the zoomed and cropped region of interest as a special effect second image.

The method as noted above is based on the assumption that areas which include human faces in an image are areas of interest for the consumer. Therefore, with the method of the invention as noted above, it is possible through the use of traditional algorithms which are adapted to detect flesh colors in an image, to find the area of interest and specifically, areas where human faces are present. At that point, the present invention permits a zooming and cropping around this region of interest so as to create a special effect second image which is to be used for the second special effect preview print.

The present invention also provides for an imaging service method which comprises the steps of obtaining a digital record of a customer image order containing a plurality of images; selecting at least one image from the plurality of images for printing as a special effect preview print; rendering the at least one image as a first image in accordance with instructions from the customer in the image order; and forming a second image having a visual special effect by modifying a visual appearance characteristic of the one image.

The present invention further provides for an imaging service method which comprises the steps of obtaining a digital record of a customer image order containing at least one image; printing the at least one image in accordance with the customer image order on a first section of a medium; and printing the at least one image as a sticker print with an adhesive backing on a second section of the medium.

The present invention further provides for a special effect preview print which comprises a first section that includes an image printed in accordance with a customer order; and a second section that extends from the first section that comprises a zoom and cropped version of the image, wherein the zoom and cropped version of the image comprises at least a region of interest in the image.

The present invention further relates to a special effect preview print that comprises a first section that includes an image printed in accordance with a customer order; and a second section that extends from the first section that comprises a further version of the image. The further version of the image has a visual special effect applied thereto in a manner in which a visual appearance characteristic of the image is modified.

The present invention further relates to a special effect preview print that comprises a first section that includes an image printed in accordance with a customer order; and a second section that extends from the first section onto which the image is provided thereon as a sticker print having an adhesive backing.

The present invention further relates to a special effect preview print arrangement that comprises a first print comprising an image printed in accordance with a customer order; and a second print comprising at least a zoom and cropped version of the image, with the zoom and cropped version of the image comprising at least a region of interest of the image.

The present invention further relates to a special effect preview print arrangement that comprises a first print which includes an image printed in accordance with a customer order; and a second print that comprises a further version of the image, with the further version of the image having a visual special effect applied thereto in a manner in which a visual appearance characteristic of the image is modified.

The present invention further relates to a special effect preview print that comprises a first print that includes an image printed in accordance with a customer order; and a second print in which the image is provided thereon as a sticker print having an adhesive backing.

### BRIEF DESCRIPTION OF THE DRAWINGS

FIG. 1 is a schematic view of an apparatus which can be used to create a special effect preview print in accordance with the present invention;

FIG. 2 is a schematic view of a modified system which can be used to create a special effect preview print in accordance with the present invention;

FIG. 3 schematically illustrates a processing or photofinishing system which can be utilized to create a special effect preview print in accordance with the present invention;

FIGS. 4A-4B illustrate one example of preparing a special effect preview print in accordance with the present invention, wherein a region of special interest is created utilizing a zoom and crop method;

FIGS. 5A-5B is a further example of a zoom and crop method similar to FIGS. 4A-4B;

FIGS. 6A-6B illustrate the creation of a special effect preview print in accordance with a feature of the present invention;

FIGS. 7A-7E illustrate examples of special effect preview prints which can be created utilizing the method of the present invention;

FIG. 8 is a further example of a special effect preview print in accordance with the present invention;

FIGS. 9A-9C are further examples of a special effect preview print in which the special effect image is provided in the form of a sticker print; and

FIGS. 10A-10C are further examples of presenting a special effect preview print to a consumer or customer.

### DETAILED DESCRIPTION OF THE INVENTION

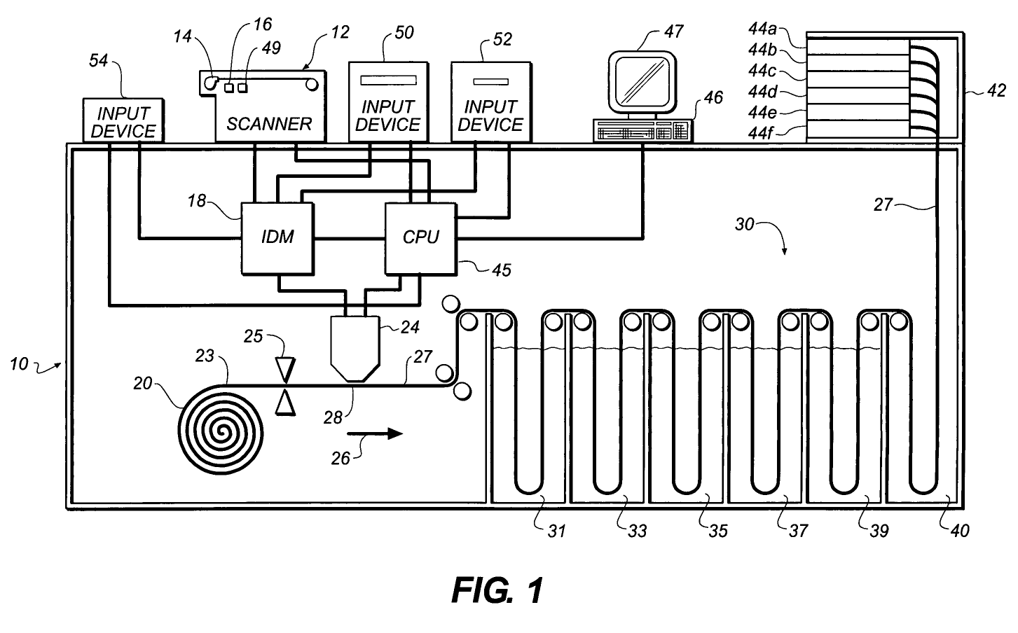

Referring now to the drawings, wherein like reference numerals represent an identical or corresponding parts throughout the several views, FIG. 1 illustrates an example of an apparatus 10 that is adapted to print digital images onto photosensitive media (material). In particular, apparatus 10 is of the type commonly referred to as a photographic minilab. As is typical of most minilabs, customer image orders are provided for printing of images onto a photosensitive media. A customer image order, for the purpose of the present invention, can be a roll of developed photographic film, a digital record file of a printing order containing a plurality of images thereon, or an order received via the internet. In a particular embodiment illustrated, apparatus 10 includes a scanner 12 which is designed to receive and scan a roll of developed film 14. The roll of developed film 14 is transported past sensor 16 in scanner 12 which scans the images on the film so as to provide a digital record of the customer images. Scanner 12 scans at a resolution sufficient to provide the desired quality prints. The digital record of the image is then forwarded to an image data manager (IDM) 18 wherein the images are manipulated as preprogrammed. In the embodiment illustrated, IDM 18 comprises a computer (microprocessor) used for manipulation of the digital images contained in the digital record file. IDM 18 also includes a memory for storing of the digital record of the customer image order.

Apparatus 10 further includes a supply roll 20 containing a web of photosensitive media 23, which in the present invention comprises photographic paper. A cutting mechanism 25 is provided for cutting the web of photosensitive media into individual cut sheets. Mechanism 25 may cut the web into sheets having any desired lengths. Appropriate transport mechanisms, not shown, are provided for advancing of the cut sheets in the direction indicated by arrow 26 along processing path 27 through apparatus 10. In particular, the cut sheets are transported from cutting mechanism 25 to an exposure gate 28 where a digital printer 24 exposes the individual images of the customer image order onto individual cut sheets, respectively, as they pass exposure gate 28. In the particular embodiment illustrated, digital printer 24 can be a printer which scans a light containing image data onto cut sheets as they move in the direction indicated by arrow 26 pass exposure gate 28. Since printer 24 is a digital printer and cutting mechanism 25 may cut the web of photosensitive media 23 into any desired length sheets, the images produced on the cut sheets may be provided in a variety of different format sizes being constrained only by the printing capabilities of printer 24 and the width of the web of photosensitive media 23. It is also to be understood that printer 24 may be any appropriate digital printer, for example, a CRT printer, an LED printer, an LCD printer, a laser printer or other types of digital printers that can print onto a photosensitive media. In the embodiment illustrated, web of photosensitive media 23 comprises photographic paper, however, the medium may comprise other media capable of being printed on by a digital printer. In the embodiment illustrated, the web of photosensitive media is first cut into individual cut sheets prior to printing, however, the present invention is not so limited. The digital images may be first printed on the web of photosensitive media 23 which at some later time before or after processing, is to be cut into individual cut sheets forming individual prints, with each print being representative of a print of a single customer order.

As is typical with minilabs, apparatus 10 is further provided with a processing section 30 wherein the cut sheets, after leaving exposure gate 28, are passed therethrough for development as is customarily done in such devices. For the particular embodiment illustrated, the cut sheets are passed through a developer station 31 containing a developer solution, a bleach/fix station 33 containing a bleach/fix solution, a plurality of wash stations 35, 37 and 39 each containing washing solution, and through a dryer section 40 for drying of the photosensitive media. The individual prints of the images are then forwarded to a sorter 42 where the prints for each customer image order are collated into separate bins 44a-f, with each bin receiving an individual customer image order. It is to be understood that any number of desired bins 44a-f may be provided as appropriate for the apparatus 10 and sorted in accordance with any desired sorting criteria.

As is customary, a CPU (computer) 45 is as provided for controlling operation of apparatus 10 and its various components. A user/operator interface 46 which includes a viewing screen 47 is also provided for allowing an operator to enter instructions for operation of apparatus 10 and monitor operation of the apparatus as is customarily done.

An appropriate computer printing program is provided for controlling operation of IDM 18. The program is provided in an appropriate format which allows loading of the program into apparatus 10 which causes IDM 18 to perform the required steps. In particular, the computer program may be designed so that IDM 18 will first obtain and store a complete customer image order prior to printing. Appropriate enhancements algorithms, which have been pre-programmed into IDM 18, are applied to the customer image order so as to improve the overall aesthetic appearance of the images when printed. It is to be understood that any desired enhancements and/or corrections may be applied to the images. As an example, the process of producing a digitally enhanced image can comprise changing pixel values to maximize content that is captured either on film or digitally. As a further example, but not by way of limitation, the following are a few other enhancements that may be applied: contrast adjustment, red eye removal, color balance, removal of dust marks or scratches and sharpness adjustments. In addition, custom corrections, such as crop and zoom can be programmed or manually entered into digital printer. After the stored digital images are enhanced, they are forwarded to printer 24 for printing.

Therefore, as an example, a customer image order can be provided and forwarded to a photofinisher. This typically takes the form of an undeveloped or developed roll of film which is sent to the photofinisher or images can be provided via the internet or in some other type of digital format. If the film is undeveloped, the photofinisher will develop the film as is customarily done in the art. Once the film has been developed, it is passed onto apparatus 10 where the images of the customer image order are scanned and forwarded onto IDM 18. Appropriate image enhancement software programs, as previously discussed, are provided in IDM 18 for analyzing the images and providing appropriate enhancements/corrections automatically to the images. The images of the customer image order are then sent to printer 24 for printing.

In a preferred embodiment, the enhancements to the images can be applied automatically, however, an appropriate display screen on apparatus 10 may be provided for previewing of the images by an operator who can make custom enhancements/modifications to the images which can then be sent to the printer for printing.

In the embodiment discussed above, the images for printing can be obtained by scanning a developed roll of photosensitive film such as 35 mm or APS film. However, the present invention is not limited thereto. As illustrated in FIG. 1, the image data and the customer image order may be obtained from a variety of different sources (such as digital still cameras, the internet, etc.), whereby a customer image order may be submitted for printing, including providing information of where the printed images are to be forwarded. For example, image input devices 50, 52, 54 may be provided wherein input device 50 may provide the images supplied on a CD, device 52 can be used to obtain images provided on a computer disk, and a communication modem 54 may be provided to receive images over the internet, or from any other source that can forward digital images. Other digital input devices, such as a digital camera, may also be used.

In the illustrated embodiment, the apparatus 10 does the printing, however, the present invention is not so limited. For example, the images can be forwarded onto a different device for storage, printing and/or display. For example, IDM 18 may forward the images through modem 54 to a customer or other device for providing and/or storing images. That is, the system of the present invention can be adapted to send images remotely via the internet to a customer's home computer, a remote printer or a selected location.

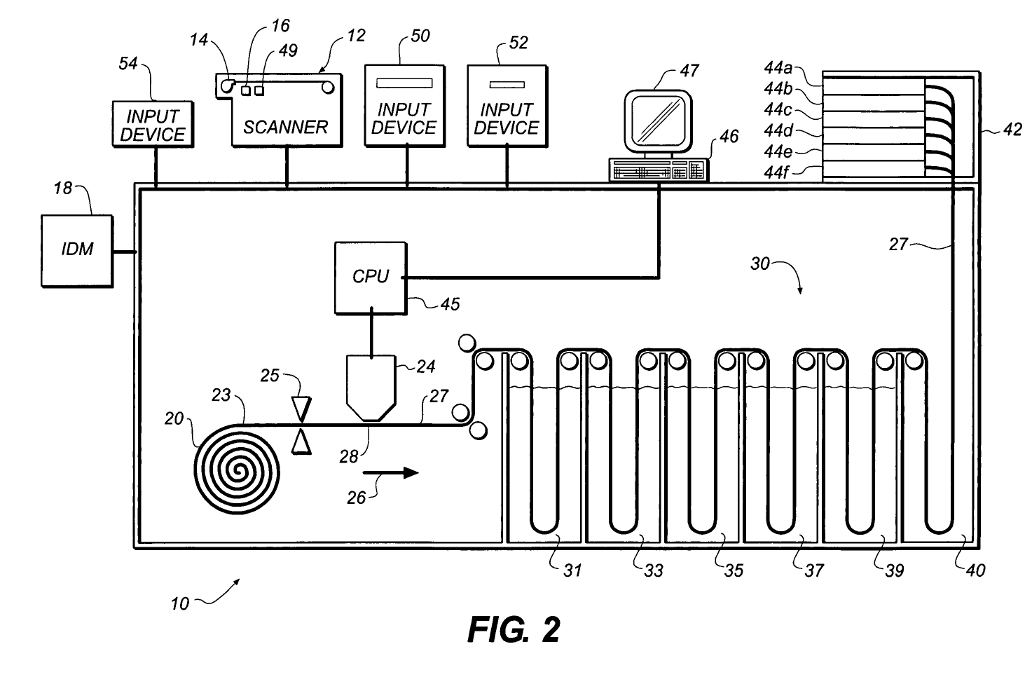

In the embodiment illustrated in FIG. 1, the individual components are illustrated as a single apparatus 10. However, the present invention is not so limited. Referring to FIG. 2, there is illustrated a modified form of the present invention, like numerals indicating like parts and operation as previously discussed. In the embodiment, scanner 12, IDM 18 and devices 50, 52, and 54 are shown as separate individual components from apparatus 10, which is used for printing the images onto the photosensitive media. The operation and function of all the elements are the same except that the individual components are discrete elements that can be separate from each other and connected by appropriate communication lines as is well known to those of ordinary skill in the art.

In the embodiment illustrated the processing of the photosensitive media is done by apparatus 10. However, the present invention is not so limited. For example, the images may be printed on the web of photosensitive material 23 and forwarded in web form to a processor where the images are developed after which the developed, web is forwarded onto a finishing station where the web is cut into individual prints and sorted by customer image order.

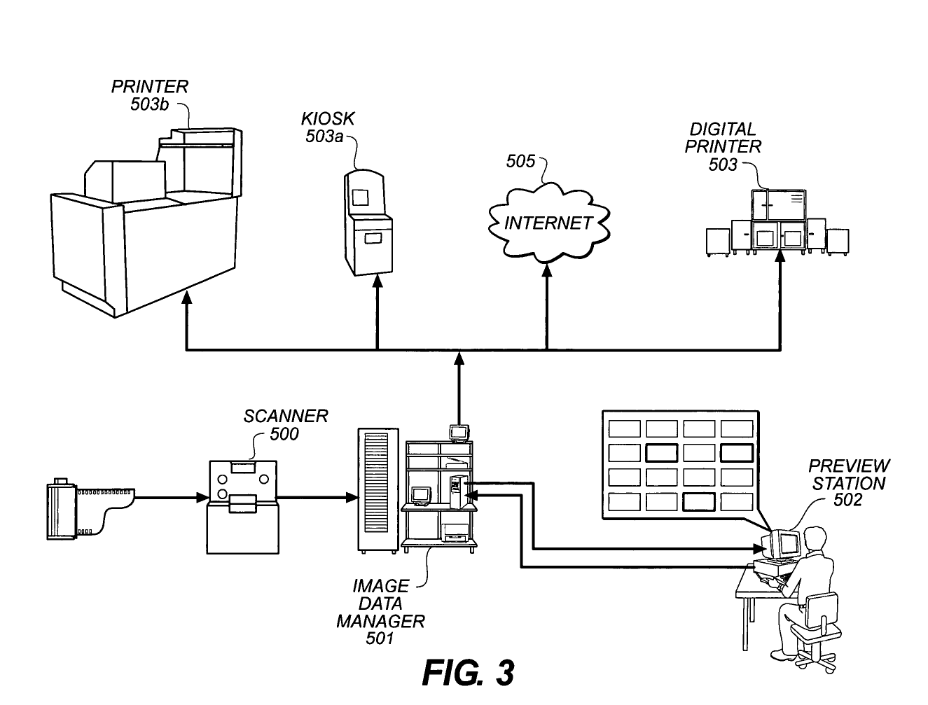

The features of the present invention can also be practiced in a wholesale lab environment as illustrated in FIG. 3. As shown in FIG. 3, a customer order including film is scanned at a scanner 500. From there, the digital record of the images is processed at IDM 501, and optionally, an operator can preview images at a preview station 502. A digital printer 503 can be operationally associated with IDM 501 to produce service prints, index prints, etc. based on a customer order. As a further option, the images can be forwarded to a customer's home computer or some further remote location via an internet connection 505. As a still further option, the images can be forwarded to a kiosk 503a operationally associated with IDM 501 via a kiosk connection or to a remote printer 503b.

The following is an example detailing further features of the present invention, which is applicable to both a minilab and wholesale lab environment. Within the context of the present invention and using the lab schematic illustration of FIG. 3 as an example, a customer order including at least a roll of exposed photosensitive film would be received at the lab. The film would be scanned by scanner 500, and the digital record of the scanned images would be sent to image data manager 501. As a further option, the images can be electronically received by IDM 501 via, for example, the internet (an electronic order).

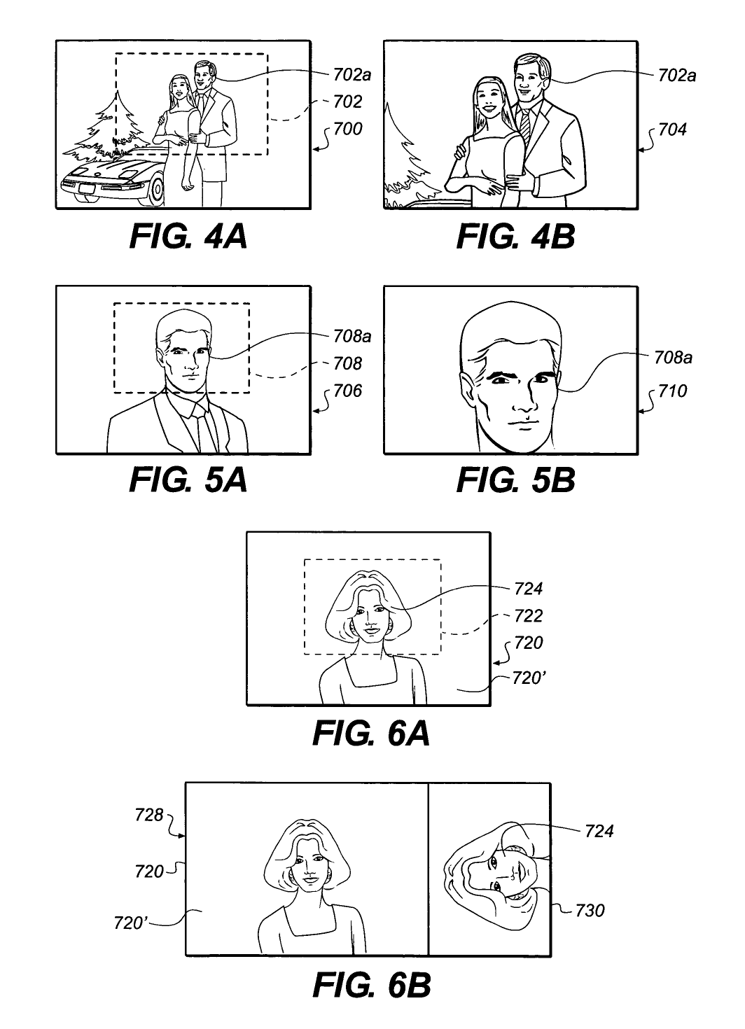

A first feature of the present invention relates to the creation of a special effect preview print based on a zoom and crop method. More specifically, in this feature of the invention, a customer image order is processed in a normal manner as noted above, so as to create photographic prints for the customer. In one aspect of the present invention, the photofinisher can automatically or manually select an image which is to be utilized as a candidate for a special effect preview print. As a basis for the selection of a candidate for a special effect preview print, it is generally recognized that those images which include human faces have more of an interest to a consumer or customer. If the selection is to be done automatically, algorithms are known which can detect human flesh tone in an image. Therefore, in this first feature of the present invention, a photofinisher can either automatically or manually find a region of interest in an image and select that image as a candidate for a special effect preview print. In the present example, the region of interest is a region which includes a human face. Once the human face is located either manually or in an automatic method utilizing flesh tone algorithms, IDM 18 can be adapted to zoom and crop around the face or faces of the region of interest. More specifically, looking at the examples of FIGS. 4A and 4B, a print or image in accordance with a customer order is shown by reference numeral 700 (FIG. 4A). If print or image 700 is to be utilized as a candidate for the creation of a special effect preview print, IDM 18 through the use of integrating ANSEL face detection algorithms can be used to find a region of interest 702 which includes human faces 702a. IDM 18 can then be controlled so as to zoom and crop around region of interest 702 and specifically around human faces 702a as shown by print or image 704 in FIG. 4B.

FIGS. 5A-5B illustrate a further example of the zoom and crop method described above. In FIG. 5A, it is shown that print or image 706 has been chosen as a candidate for the creation of a special effect preview print. Utilizing ANSEL face detection algorithms, region of interest 708 which includes a human face 708a can be identified, and the appropriate software can be controlled to zoom and crop around region of interest 708 so as to create a final image or print 710 as shown in FIG. 5B.

The process for creating a special effect preview print is illustrated more clearly in FIG. 6A-6B. FIG. 6A illustrates a print 720 from a customer's image order. Print 720 which is a candidate for a special effect preview print has an image 720′ therein and is processed in accordance with the customer order. Image 720′ has been selected through, for example, an ANSEL face detection algorithm. A region of interest 722 that includes human face 724 as shown in FIG. 6A can be located. Based on this information, a special effect preview print 728 can be prepared. Special effect preview print 728 includes print 720 and image 720 (FIG. 6B) processed in accordance with the customer order, and attached thereto or extending therefrom, a special effect image 730 which is basically region of interest 722 with respect to image 720′, wherein, for example, a 2×zoom and crop has been performed around human face 724. With special effect preview print 728 as shown in FIG. 6B, a customer has an opportunity to preview their images in a different format (zoom and cropped around a region of interest) to determine if such a format would be desirable from the customer's perspective.

With respect to the zoom and crop features noted above, the size of the zoom is determined by the crop area. Some predetermined radius around the faces would be set to allow room between the face and the end of the cropping region. Once the face locations are identified, the cropping algorithm would define a rectangle that is used outside the faces. For a single face, the cropped region would include the entire face plus some amount of image area to allow for a pleasing composition etc. Also, there would need to be some minimal amount of zooming allowed to make sure that the final image quality is sufficient for the output system making the prints or displaying the images.

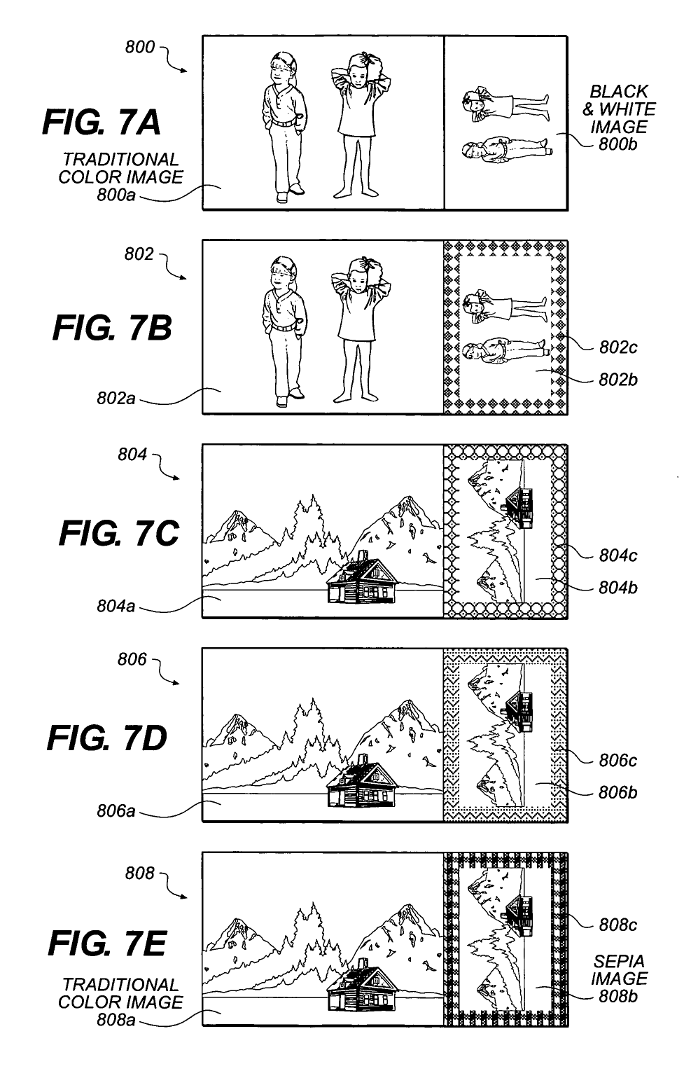

With reference to FIG. 7A-7E further preferred features and options for creating a special effect preview print are shown. More specifically, in addition to zooming and cropping around a region of interest, a special effect preview print can be provided which changes the appearance, characteristic or look of a selected image from the customer order. As described in FIG. 6A-6B, one example for creating the special effect preview print is to include a regular size print of the customer's image and attach thereto a zoom and cropped version of the customer's image as the special effect image.

A further example of a special effect preview print in accordance with the present invention is illustrated in FIG. 7A. As shown in FIG. 7A, the special effect preview print 800 includes the customer's image 800a which is processed in accordance with the customer's order and is provided on one section of special effect preview print 800, and a special effect image 800b which is provided on a second section of special effect preview print 800. In the example of FIG. 7A, the customer's original image 800a is processed in accordance with the customer's order as a conventional traditional color image. Special effect image 800b in the example of FIG. 7A is a black and white version of the customer's image. This would provide the customer with an opportunity to view their image as a black and white image.

In the example of FIG. 7B, the special effect image comprises the customer's image with a special or decorative border. More specifically, as shown in FIG. 7B, a special effect preview print 802 includes a first section that comprises the customer's image 802a which is processed in accordance with the customer's image order, and a second section with a special effect image 802b. Special effect image 802b is essentially a version of image 802a having decorative border 802c around the image.

FIG. 7C is another example of creating a special effect image with a special border. Special effect preview print 804 of FIG. 7C includes image 804a processed in accordance with the customer's original image order and special effect image 804b having a decorative border 804c therearound. As shown in FIG. 7D, a special effect preview print 806 includes image 806a processed in accordance with the customer's original image order, and a special effect image 806b having still another type of special border 806c therearound.

Finally, FIG. 7E discloses a special effect preview print 808 which includes a customer image 808a processed in accordance with the customer's image order, (for example, a traditional color image) and a special effect image 808b which can have a specific characteristic look applied thereto such as a sepia look, a high color look, a black and white look, etc. in combination with a special border 808c.

In all of the examples of FIGS. 7A-7E, any type of special effect can be applied to the special effect images either individually or in combination. For example, the special effect image can include the combination of a zoom and crop to a human face in the customer's image order, and a modification of the original image to a black and white image. In addition, the special effect image can include a combination of a special appearance characteristic such as sepia, black and white, high color, cartoon, zoom and crop, etc., either alone or in combination with a decorative border and/or a zoom and crop effect.

With respect to the special effect preview print, it is preferable that the image which is processed in accordance with the customer's order be provided as a full size print while the special effect preview image be provided as smaller image or at least two wallet size images. Further, with respect to the selection of an image to be printed as a special effect preview print, as noted above, one criteria would be to examine or analyze the customer's images to find those image which includes human faces. For this purpose, special face detection algorithms can be used. However, the present invention is not limited thereto and images which include landscapes, houses, architectures, animals, horizons, etc., can be used as a special effect preview print. As an example, the image content of the images in the customer's orders can be examined to determine what type of images are more prevalent within the custom order. For example, the image content could be mostly landscaped scenes where it is determined that the special effect preview print can be a landscaped print. At the same time, if the images are of a sporting event, the special effect preview print can be an image that includes individuals either participating or viewing the sporting event.

With respect to borders, it is noted that some borders do not compliment the image content or color. In some cases, the border may detract from the picture by distracting the eye and ruining the overall effect of the image. In a feature of the present invention, the images chosen for a special effect print that includes a border can be examined to determine the make-up of the borders. For example, if the overall color of the image is more earth tones then a complimentary border could be selected to enhance the picture. If the picture has multiple bright colors then a more solid or muted or white border is more appropriate. Also, if the image content were known, then an appropriate border style or type could be selected. For example, if the image content is a party, then a blue border with balloons may be appropriate, while if the image content includes babies, a teddy bear border may be more appropriate.

Additionally, as noted above, each of the special effect images provided on a special effect preview print can have their appearance characteristic or look changed or modified to convert the original image into a black and white image, a sepia image, a high color image, a cartoon image, etc.

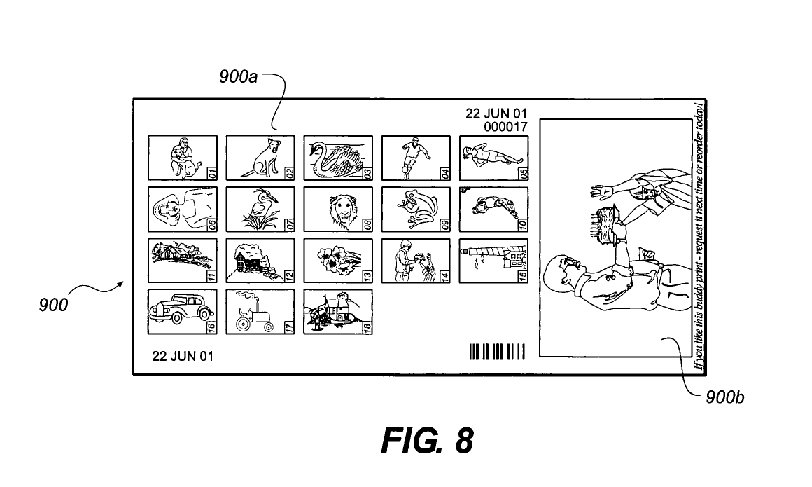

A further option for delivering a special effect preview print to the customer is shown in FIG. 8. FIG. 8 illustrates a special effect preview print 900 in which an index print 900a is provided on one section or side of special effect preview print 900 and a special effect image 900b is provided on a second section or side of special effect preview print 900. Special effect image 900b could be a modified version of a customer original image which appears in the index print and can be either zoom and crop, black and white, sepia, cartoon, bordered, etc., or a combination thereof.

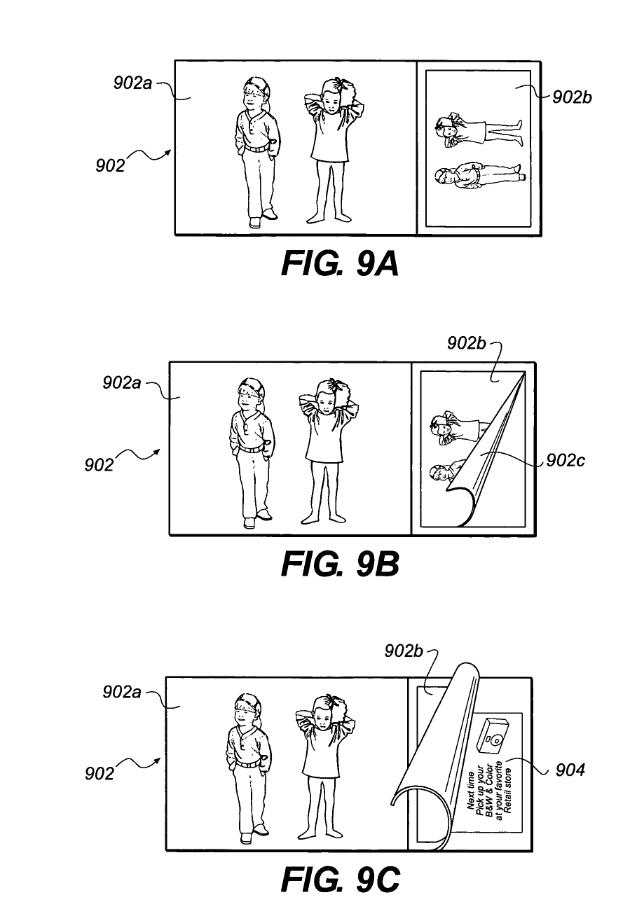

FIGS. 9A-9C illustrate a further example of a special effect preview print in accordance with the present invention. FIG. 9A illustrates a special effect preview print 902 which includes a first section having a customer image 902a processed in accordance with the customer order and a second section which includes a special effect image 902b. As shown in FIG. 9A special effect image 902b could be a smaller version of image 902. A feature of special effect preview print 902 is that special effect image 902b is provided in the form of a sticker print. That is, as shown in FIG. 9b, special effect image 902b is a sticker print having an adhesive backing 902c which is provided on the second section of special effect print 902. Special effect image 902b could be color, black and white, high color, sepia, zoom and crop, cartoon, bordered, etc.

As a still further option as shown in FIG. 9c, advertising material 904 can be placed under sticker print special effect image 902b. The advertising material can preferably be related to the type of appearance and/or special characteristics provided to sticker print special effect image 902b.

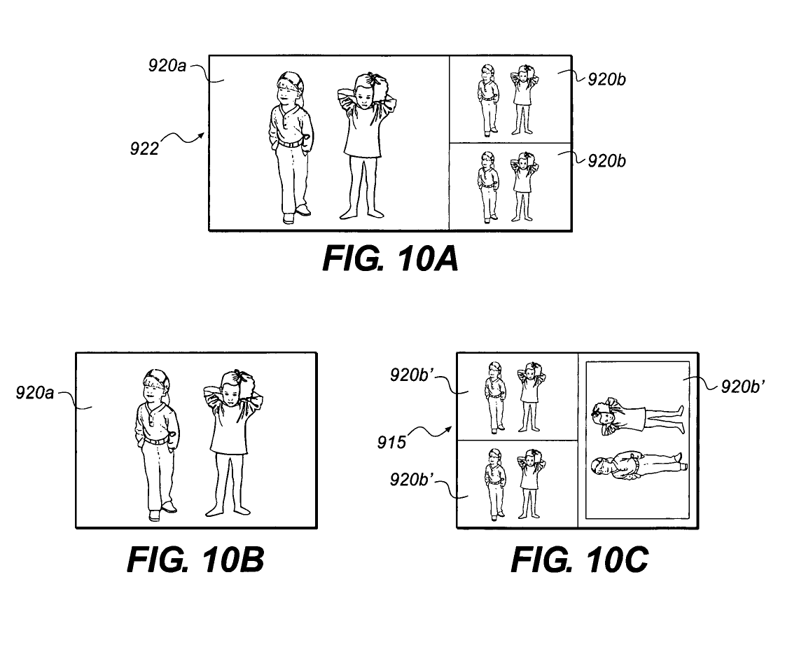

As a still further option and with respect to FIGS. 10A-10C, FIG. 10A shows a special effect preview print 922 having a customer image 920a on one side processed in accordance with the customer's instructions and special effect preview images 920b. As opposed to a single print as shown in FIG. 10A, the special effect preview print can be in the form of a special effect preview print arrangement in which image 920a is provided as a traditional print as shown in FIG. 10B, and the special effect preview prints can be provided on a separate photographic media. More specifically, or as shown in FIG. 10C, special effect preview images 920b′ can be provided on separate media 915. As in the previous embodiments, special effect preview images 920b′ can be zoomed and cropped, black and white, high saturation color, sepia, bordered, etc., or a combination of any of the above.

Therefore, the special effect images as described gives the consumer the opportunity to view their images in a form where the image has a different characteristic or look applied to it and to order those images which he/she likes. Further, although the present invention has been described as special effect preview print, the present invention can be practiced electronically to permit a customer to view the images while they are displayed on a monitor. That is, using internet orders as an example, the special effect preview image as well as the customer image processed in accordance with the customer order can be sent via the internet to the customer's home computer. The customer who can then review the images on his/her home computer display and order the appropriate prints online.

The invention has been described in detail with particular reference to certain preferred embodiments thereof, but it will be understood that variations and modifications can be effected within the spirit and scope of the invention.

What is claimed is:

1. An imaging service method comprising the steps of:
obtaining a digital record of a customer image order containing a plurality of images;
selecting at least one image from said plurality of images for printing as a special effect preview print;
reading said at least one image to find a region of interest in said at least one image
zooming and cropping around the region of interest in said at least one image;
rendering said at least one image as a first image in accordance with instructions from the customer in the image order; and
rendering said zoomed and cropped region of interest as a special effect second image.

2. A method according to claim 1, comprising the further step of:
printing said first image and said second image.

3. A method according to claim 2, wherein said first image is a first size and said second image is a second size which is smaller than said first size.

4. A method according to claim 2, wherein said printing step comprises printing said first and second images adjacent to each other to form a special effect preview print.

5. A method according to claim 2, wherein said printing step comprises printing said first image on a first print and printing said second image on a second print separate from said first print.

6. A method according to claim 1, wherein said region of interest in said at least one image is an area that comprises at least one face.

7. A method according to claim 6, wherein said zooming and cropping step comprises performing a zoom centered around the at least one face and cropping around an area that includes the at least one face.

8. A method according to claim 1, comprising the further step of printing an index print which includes thumbnail images of the plurality of images in the customer order, wherein said second image is printed adjacent to said index print.

9. A method according to claim 1, comprising the further step of applying a visual appearance characteristic to said second image by converting said second image to a black and white image, a sepia image, a cartoon image, a saturated color image or a bordered image.

10. A method according to claim 1, comprising the further steps of:
reading the second image to determine a color content of the image; and
adding a border around the second image, said border having a color complimentary to the color content of the second image.

11. A method according to claim 1, comprising the further steps of:
reading the second image to determine an image content of the second image; and
adding a border around the second image, said border having an appearance which is related to the image content of the second image.

12. A method according to claim 4, wherein said second image is provided on a support having an adhesive backing so as to define a sticker print, such that sticker print is provided on a portion of said special effect preview print which is adapted to receive said sticker print thereon, and said special effect preview print includes said first image and said sticker print.

13. A method according to claim 5, wherein said second image is provided on a support having an adhesive backing so as to define a sticker print

14. An imaging service method comprising the steps of:
obtaining a digital record of a customer image order containing a plurality of images;
selecting at least one image from said plurality of images for printing as a special effect preview print;
rendering said one image as a first image in accordance with instructions from the customer in the image order, said first image having a first size; and
forming a second image having a visual special effect by modifying a visual appearance characteristic of said one image.

15. A method according to claim 14, comprising the further step of:
printing said first image and said second image adjacent to each other to form said special effect preview print.

16. A method according to claim 13, wherein said forming step comprises converting said one image to a black and white image, a sepia image, a cartoon image, a saturated color image or a bordered image.

17. A method according to claim 13, wherein said second image is smaller in size than said first image.

18. A method according to claim 15, further comprising:
printing the plurality of images in the customer image order including the selected at least one image in accordance with the customer instructions.

19. A method according to claim 15, wherein said second image is provided on a support having an adhesive backing so as to define a sticker print, such that the sticker print is provided on a portion of said special effect preview print which is adapted to receive said sticker print thereon, and said special effect preview print includes said first image and said sticker print.

20. A method according to claim 15, further comprising the step of removably attaching media having at least one of visual text, symbols or numbers thereon to said special effect preview print.

21. A method according to claim 19, further comprising the step of providing at least one of text, symbols or numbers on said portion of said special effect preview print which is adapted to receive said sticker print thereon, said visual text, symbols or numbers being located below said sticker print when said sticker print is attached to said special effect preview print and being visible when said sticker print is removed from said special effect preview print.

22. An imaging service method comprising the steps of:
obtaining a digital record of a customer image order containing at least one image;
printing said at least one image in accordance with the customer order on a first section of media; and
printing said at least one image as a sticker print with an adhesive backing on a second section of the media

23. A method according to claim 22, wherein said at least one image printed on said sticker print comprises a modified visual appearance.

24. A special effect preview print comprising:
a first section comprising an image printed in accordance with a customer order; and
a second section extending from said first section comprising a zoom and cropped version of said image, said zoom and cropped version of said image comprising at least a region of interest in said image.

25. A preview print according to claim 24, wherein said region of interest in said image comprises an area that includes at least one face.

26. A preview print according to claim 24, wherein said zoom and cropped version of said image comprises a visual appearance characteristic which is different from an appearance characteristic of the image on said first section of said print.

27. A preview print according to claim 26, wherein said different visual appearance characteristic defines a black and white image, a sepia image, a cartoon image, a saturated color image or a bordered image.

28. A preview print according to claim 24, wherein said zoom and cropped version of the image is in the form of a sticker print having an adhesive backing which is adapted to be provided on said second section of said print.

29. A special effect preview print comprising:
a first section comprising an image printed in accordance with a customer order; and
a second section extending from said first section comprising a further version of said image, said further version of said image having a visual special effect applied thereto in a manner in which a visual appearance characteristic of said image is modified.

30. A preview print according to claim 29, wherein said modified visual special effect comprises a black and white image, a sepia image, a cartoon image, a saturated color image or a bordered image.

31. A preview print according to claim 29, wherein said further version of said image is in the form of a sticker print.

32. A special effect preview print comprising:
a first section comprising an image printed in accordance with a customer order; and
a second section extending from said first section comprising onto which said image is provided thereon as a sticker print having an adhesive backing.

33. A special effect preview print arrangement comprising:
a first print comprising an image printed in accordance with a customer order; and
a second print comprising at least a zoom and cropped version of said image, said zoom and cropped version of said image comprising at least a region of interest in said image.

34. An arrangement according to claim 33, wherein said region of interest in said image comprises an area that includes at least one face.

35. An arrangement according to claim 33, wherein said zoom and cropped version of said image comprises a visual appearance characteristic which is different from an appearance characteristic of the image on said first print.

36. An arrangement according to claim 35, wherein said different visual appearance characteristic defines a black and white image, a sepia image, a cartoon image, a saturated color image or a bordered image.

37. An arrangement according to claim 33, wherein said zoom and cropped version of the image is in the form of a sticker print having an adhesive backing.

38. A special effect preview print arrangement comprising:
a first print comprising an image printed in accordance with a customer order; and
a second print comprising a further version of said image, said further version of said image having a visual special effect applied thereto in a manner in which a visual appearance characteristic of said image is modified.

39. An arrangement according to claim 38, wherein said modified visual appearance characteristic defines a black and white image, a sepia image, a cartoon image, a saturated color image or a bordered image.

40. An arrangement according to claim 38, wherein said further version of said image is in the form of a sticker print.

41. A special effect preview print arrangement comprising:
a first print comprising an image printed in accordance with a customer order; and
a second print in which said image is provided thereon as a sticker print having an adhesive backing.
